(19) United States
(12) Patent Application Publication
(10) Pub. No.: US 2025/0115153 A1
(43) Pub. Date: Apr. 10, 2025

(54) VEHICLE

(71) Applicant: TOYOTA JIDOSHA KABUSHIKI KAISHA, Toyota-shi (JP)

(72) Inventor: Hiroki SUGIURA, Toyokawa-shi (JP)

(73) Assignee: TOYOTA JIDOSHA KABUSHIKI KAISHA, Toyota-shi (JP)

(21) Appl. No.: 18/754,459

(22) Filed: Jun. 26, 2024

(30) Foreign Application Priority Data
Oct. 4, 2023 (JP) 2023-172802

(51) Int. Cl. B60L 53/66; B60L 53/62

(52) U.S. Cl. CPC B60L 53/66; B60L 53/62

(57) ABSTRACT

A vehicle performs power transfer between the vehicle and electrical equipment while communicating therewith. A control device requests the electrical equipment to wait during the power transfer, sets the vehicle to the standby state when the standby request is accepted by the electrical equipment, and resumes the power transfer when the resumption condition is satisfied when the vehicle is in the standby state. The standby includes a first standby in which the vehicle stands by in a state in which the power transfer is stopped but the communication with the electrical equipment is maintained, and a second standby in which the vehicle stands by in a state in which both the power transfer and the communication therewith are stopped. The control device determines which of the first standby and the second standby is required for the electrical equipment by using the remaining capacity of an energy storage device.

### CROSS-REFERENCE TO RELATED APPLICATION

This application claims priority to Japanese Patent Application No. 2023-172802 filed on Oct. 4, 2023, incorporated herein by reference in its entirety.

### BACKGROUND

### 1. Technical Field

The present disclosure relates to vehicles that perform power transfer.

### 2. Description of Related Art

Japanese Unexamined Patent Application Publication No. 2013-176274 (JP 2013-176274 A) discloses a technique for maintaining communication between charging equipment (electrical equipment) and a vehicle during charging.

### SUMMARY

In recent years, the capacity of energy storage devices mounted in vehicles has been increasing. Such an increase in capacity of the energy storage devices will also increase their charging time. The energy storage devices mounted in vehicles can also be used for power transfer other than charging (such as discharging to the outside of the vehicles). However, users do not necessarily want to continue such power transfer for a long time. There is also a possibility that power transfer cannot be performed for a certain period of time due to some circumstances. Therefore, when performing power transfer for a long period of time, it is possible that the power transfer is paused, the vehicle is put on standby with the power transfer paused, and the power transfer is resumed at an appropriate timing. In such a power transfer method, however, standby power consumption increases if the vehicle is on standby with communication between the vehicle and electrical equipment maintained. On the other hand, if the vehicle is on standby with the communication stopped, the process of resuming the power transfer is performed after the communication is resumed, which delays the resumption of the power transfer. Therefore, there remains room for improvement in how the vehicle is put on standby.

The present disclosure was made to address the above issue, and an object of the present disclosure is to put a vehicle into an appropriate standby state according to the situation of the vehicle when putting the vehicle on standby with power transfer stopped.

A vehicle according to an aspect of the present disclosure includes a control device and an energy storage device.

The vehicle is configured to perform power transfer between the vehicle and electrical equipment while communicating with the electrical equipment.
The control device is configured to send a request for standby to the electrical equipment during the power transfer, and put the vehicle into a standby state when the request for the standby is accepted by the electrical equipment, and to resume the power transfer when a resumption condition is satisfied while the vehicle is in the standby state.
The standby includes first standby in which the vehicle stands by with the power transfer stopped but with communication with the electrical equipment maintained, and second standby in which the vehicle stands by with both the power transfer and the communication with the electrical equipment stopped.
The control device determines which of the first standby and the second standby is to be requested to the electrical equipment by using a remaining capacity of the energy storage device.

According to the present disclosure, it is possible to put a vehicle into an appropriate standby state according to the situation of the vehicle when putting the vehicle on standby with power transfer stopped.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a power transfer system according to an embodiment of the present disclosure;

FIG. 2 is a flowchart illustrating charge control according to an embodiment of the present disclosure;

FIG. 3 is a flowchart showing details of the standby control shown in FIG. 2;

FIG. 4 is a flow chart showing a variation of the process shown in FIG. 3; and

FIG. 5 is a diagram illustrating a modification of the configuration illustrated in FIG. 1.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

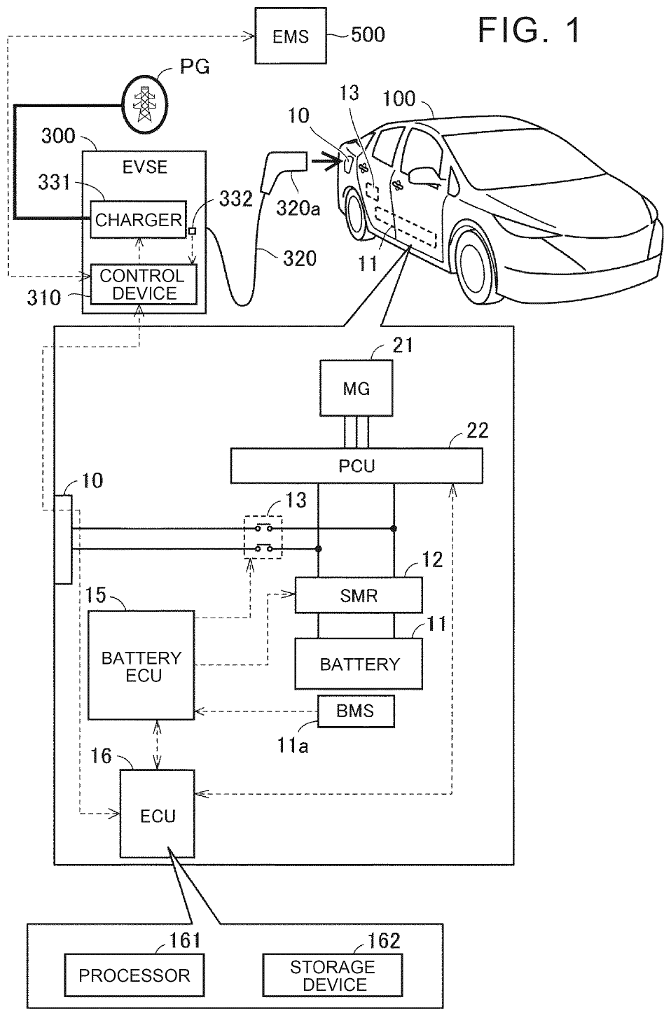

FIG. 1 is a diagram illustrating a power transfer system according to an embodiment of the present disclosure. The power transfer system shown in FIG. 1 includes a vehicle 100, a EVSE 300, and an EMS 500. “EVSE” means electric vehicle supply equipment. “EMS” means energy management system. EVSE 300 is supplied with power from a power system PG. The power system PG is a power grid constructed by a transmission and distribution facility. A plurality of power plants (not shown) is connected to the power system PG. The power system PG supplies AC power via, for example, a transformer (not shown).

EVSE 300 includes a control device 310, a charger 331, and a detector 332, and includes a charge cable 320. The charge cable 320 has a connector 320a (charging connector) at its distal end, and includes a communication line and a power line therein. One electric wire may also serve both as a communication line and a power line. The control device 310 functions as a SECC that communicates with one or more EVCC, which will be described later. “EVCC” means an electric vehicle communication controller. “SECC” means supply equipment communication controller. The control device 310 may control input/output channels, data encryption, or data transmission between the vehicle 100 and EVSE 300. In addition, the control device 310 is configured to be able to interact with SA (Secondary Actor). In this embodiment, EMS 500 corresponds to SA. The control device 310 is configured to communicate with an EMS 500. EMS 500 may include a computer that manages power supply and demand balances in a building such as a house or a factory, or a computer that functions as an aggregator that bundles a plurality of resources. EMS 500 requests power transfer for energy management to the control device 310 as needed.

The control device 310 controls the charger 331. The charger 331 includes a power conversion circuit (for example, an inverter) and is configured to adjust a charging current. The detector 332 includes various sensors (for example, a current sensor and a voltage sensor) for detecting the state of the charger 331, and outputs a detection result to the control device 310. The charger 331 converts AC power supplied from the power system PG into DC power in response to a command from the control device 310, and outputs the DC power to the connector 320a. That is, EVSE 300 outputs DC power.

Vehicle 100 includes inlet 10 to which a connector 320a can be attached and detached. The vehicle 100 is electrically connected to the power system PG via EVSE 300 by connecting the connector 320a of the charge cable 320 connected to the main body of EVSE 300 to the inlet 10 of the vehicle 100 in the parked state (plug-in state). On the other hand, when the inlet 10 is not connected, the vehicle 100 is not electrically connected to each of EVSE 300 and the power system PG (plug-out state).

The vehicle 100 further includes a battery 11, a SMR (System Main Relay) 12, a charge relay 13, an ECU 15, 16, a MG (Motor Generator) 21, and a PCU (Power Control Unit) 22. Each of SMR 12 and the charge relay 13 is a high-voltage relay, and may be, for example, an electromagnetic-type mechanical relay. “ECU” means an electronic control unit. Electric power is supplied from an auxiliary battery (not shown) to the respective ECU (including ECU 15, 16) mounted on the vehicle 100. When the remaining capacity of the auxiliary battery decreases, electric power is supplied from the battery 11 to the auxiliary battery.

ECU 15 and 16 are configured to be able to communicate with each other. ECU 15 functions as a computer (battery ECU) that manages the battery 11. ECU 16 functions as a EVCC that communicates with a SECC (e.g., the control device 310). ECU 16 may control input/output channels, data encryption, or data transmission between the vehicle 100 and EVSE 300.

The battery 11 includes, for example, a secondary battery such as a lithium ion secondary battery. The vehicle 100 is configured to be able to travel using electric power stored in the battery 11. The vehicle 100 is, for example, battery electric vehicle (BEV) without engines (internal combustion engines). However, the present disclosure is not limited thereto, and the vehicle 100 may be PHEV (plug-in hybrid electric vehicle) including an internal combustion engine, or may be other electrified vehicle (xEV).

The battery 11 is provided with a BMS (Battery Management System) 11a for monitoring the status of the battery 11. BMS 11a includes various sensors for detecting the status of the battery 11, and a monitoring IC (integrated circuit) for receiving a detection signal from the various sensors. The monitoring IC generates a signal (hereinafter, referred to as a “BMS signal”) indicating the status of the battery 11 by using the detection signals from the various sensors, and outputs the generated BMS signal to ECU 15. ECU 15 acquires, for example, the temperature, current, voltage, and state of charge (SOC) of the battery 11 based on the BMS signal. The SOC indicates the remaining capacity, and represents, for example, the ratio of the current remaining capacity to the maximum available capacity, and in the range of 0% to 100%.

The vehicle 100 is configured to be capable of performing external charging (charging of the battery 11 by electric power from the outside of the vehicle). The charge relay 13 switches connection/disconnection of the charging line. During the external charging, SMR 12 and the charge relay 13 are in the closed state (connected state), and the DC power outputted from EVSE 300 to the vehicle 100 is inputted to the inlet 10, and the battery 11 is charged. ECU 15 controls SMR 12 and charge relay 13 in accordance with instructions from ECU 16. In the embodiment shown in FIG. 1, a charging line including an inlet 10 and a charge relay 13 is connected between SMR 12 and PCU 22. However, the present disclosure is not limited thereto, and a charge line may be connected between the battery 11 and SMR 12.

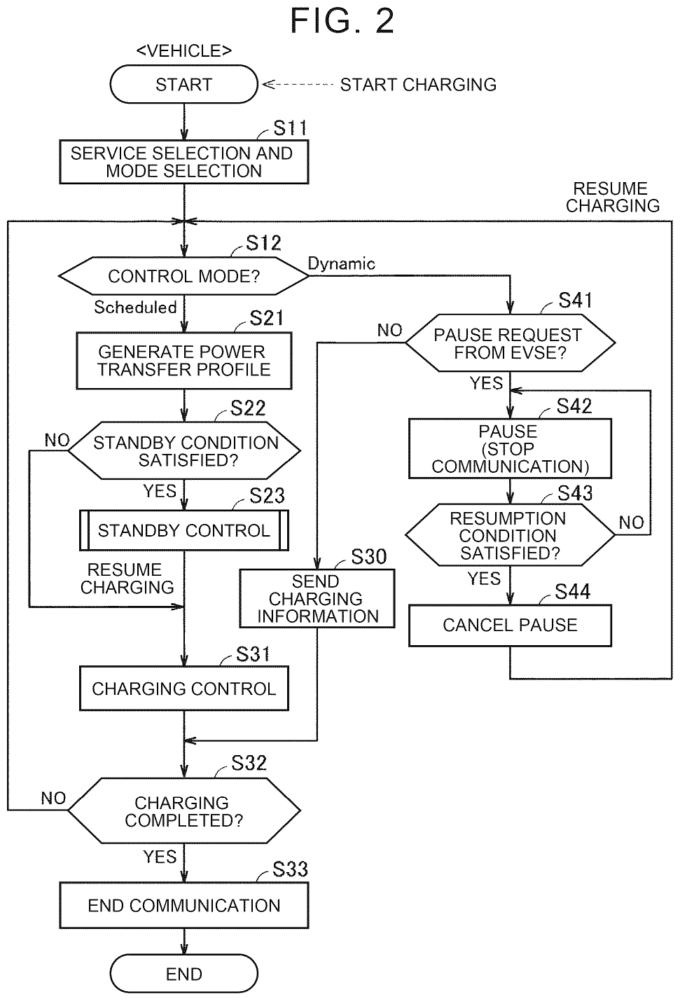

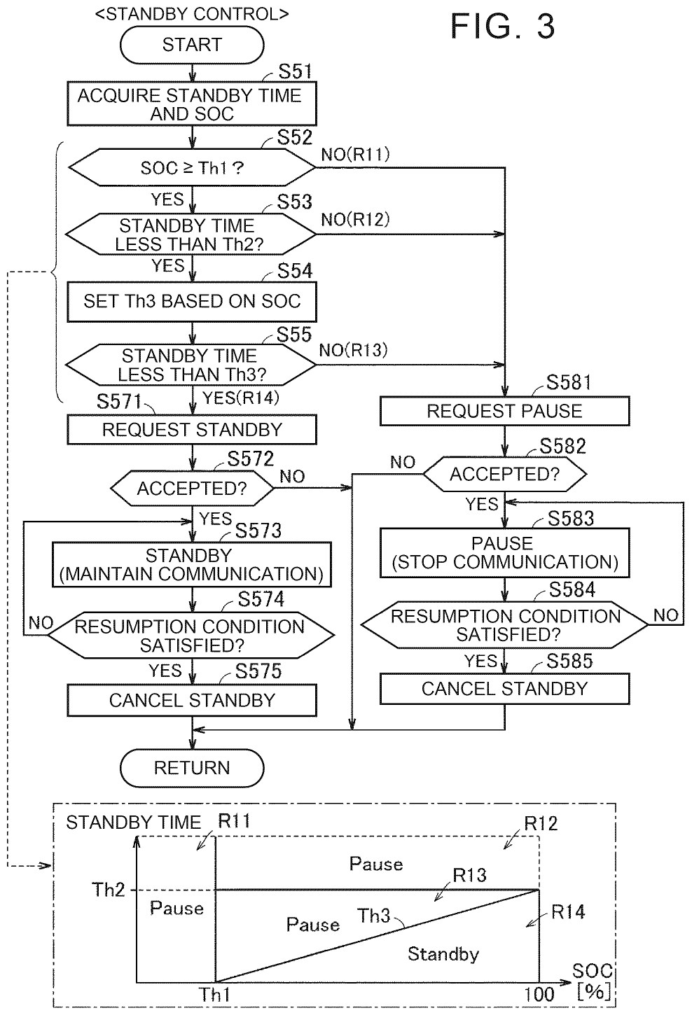

ECU 16 includes a processor 161 and a storage device 162. The storage device 162 is configured to store stored information. The storage device 162 stores various kinds of information used in the program in addition to the program. In this embodiment, the processor 161 executes a program stored in the storage device 162 to execute various kinds of control (for example, control illustrated in FIGS. 2 and 3 described later). However, these processes may be executed only by hardware (electronic circuit) without using software.

PCU 22 includes inverters and converters, for example, and drives MG 21 using power supplied from the battery 11. MG 21 is driven by PCU 22 to rotate the drive wheels of the vehicle 100. Further, MG 21 performs regenerative power generation and outputs the generated electric power to the battery 11. SMR 12 switches the connection/disconnection of the electric path from the battery 11 to PCU 22. SMR 12 is maintained in a closed state (connected state) while the vehicle 100 is traveling.

The vehicle 100 and EVSE 300 perform power transfer (for example, charging or discharging of the battery 11 in a plug-in condition). In the power transfer methods according to this embodiment, the vehicle 100 corresponding to EV (Electric Vehicle) performs power transfer between the vehicle 100 and EVSE 300 while communicating with EVSE 300. EVCC of EV (e.g., ECU 16) and SECC of EVSE (e.g., control device 310) select servicing prior to power transfer. Specifically, EVCC launches a communication session and requests a service available to SECC. SECC answers the appropriate listing of services that can be provided to EVCC. EVCC then selects the service to use and sends the service ID to SECC. SECC returns detailed information (parameter list) of the selected service. This is done in a loop. That is, SECC sequentially send the service details for each service for which EVCC requests information. EVCC then selects, for example, an energy-transfer service. This allows EVCC and SECC to exchange messages regarding physical limitations under the rated operating conditions of the selected energy-transfer service. EVCC and SECC select and negotiate servicing operations through this messaging. Once the servicing operation is determined by EVCC and SECC agreement, the message set to be applied is uniquely determined. If the power transfer is an EV charge, EVCC and SECC negotiate a control mode for the charge session during the service selection process.

In this embodiment, two types of control modes are employed, more specifically a scheduled control mode and a dynamic control mode. EVCC and SECC select one of these control modes. The parameters to be exchanged follow the selected control mode. In the scheduled control mode (first control mode), EVCC generates a power profile and EVCC and SECC negotiate the generated power profile. That is, in the scheduled control mode, power transfer is performed under the control of EVCC. On the other hand, in the dynamic control mode (second control mode), no negotiation is performed, and the control is completely left to SECC (off-board system). However, EVCC sends a limit value (for example, an upper limit value such as a charging voltage, a charging current, and a charging power) of a parameter related to use of a battery mounted on EV to SECC. SECC determines a single power set point to be complied with by EV based on the received limit value and sends the determined power set point to EVCC. As described above, in the dynamic control mode, power transfer is performed under the control of SECC.

The following signals are transferred between EVCC and SECC for power transfer. Signals defined in International Organization for Standardization (ISO) 15118-20 may be used.

EVCC requests SECC by using the following message.

The session setting request is a signal requesting the start of a communication session. EVCC setting request includes a EVCCID for specifying the sessions. The session stop request is a signal requesting termination or Pause of the power transfer process. The session stop request includes a charging session. The charging session may be set to “end” and “pause”. A session stop request in which “end” and “pause” are set in the charging session requests end and pause of the power transfer process, respectively.

The service discovery request is a signal requesting that all services provided by SECC be sent. The service discovery request includes a list of identities (service ID) that identify services supported by EV. EVCC can restrict servicing by sending such listings. The service discovery request distinguishes between different types and coverage of services. The service detail request is a signal requesting EVSE to send a particular additional information regarding the service provided. The service detailed request includes identification information (service ID) that identifies a service for which additional information is requested. The service selection request is a signal for notifying information about the selected service. The service selection request includes a selected VAS (value-added service) list. This listing contains all selected servicing ID and parameter set ID.

The power supply request (power delivery request) is a signal that requires SECC to provide power. The power supply requirement includes an EV power profile and a charge progress. EV uses EV power profile to announce and reserve a power transfer profile for the present charge session. “Start,” “Stop,” “Re-Schedule Negotiation,” and “Standby” may be set for charge progress. EVCC can request standby (hereinafter also referred to as “first standby”) and pause (hereinafter also referred to as “second standby”) from SECC using the power supply request.

A power supply request that is set to “start” in charge progress requires EVSE to prepare an energy flow for immediate start. A power supply request with “scheduled re-negotiation” set in the charging progress requires a scheduled re-negotiation mechanism. The power supply request in which “standby” is set in the charge progress requests EVSE that the EV enters the first standby period. If this requirement is accepted by EVSE, EVSE shuts down the energy-flow. During the first standby period, the power transfer between EV and EVSE is stopped (zero power). However, in the first standby period, the communication between EV and EVSE is maintained, and the contactor provided in the power transfer path is maintained in the closed state (connected state).

A power supply request that is set to “Stop” is requested to EVSE to stop the energy flow. If EVCC desires second standby (Pause), EVCC sends a power supply request to SECC with a “stop” set to charge progress, and then sends a session stop request to SECC with a “pause” set to charge session. This session stop request requests EVSE that EV enter the second standby period (pause period). If this requirement is accepted by EVSE, EVSE stops the communication after stopping the energy flow so that the energy flow is resumed at the timing indicated by EV power profile. In the second standby period, the contactor provided in the path of the power transfer is opened (cut-off state), and the power transfer between EV and EVSE is stopped (zero-power). Zero power is guaranteed by the interruption of the contactor. Further, in the second standby period, communication between EV and EVSE is stopped.

The charge-loop request is a signal that periodically notifies EVSE of information about charge. For example, in the dynamic-control mode, EVCC periodically notifies SECC of the current value of the charging parameter (charging voltage, charging current, charging power, etc.) using the charging-loop request. In the scheduled control mode, EVCC periodically notifies SECC of the current value of the charging parameter, the target value of the charging parameter requested by EV, and the difference between the target value and the current value by using the charging-loop request.

In response to a request from EVCC, SECC sends the following response-signal (message):

The session setting response is a response signal to the session setting request. The session-setup response includes a EVSEID and a response code. EVSEID is identification-information for identifying a EVSE connected to EV. The response code indicates whether the new session was launched or successfully joined to the previous communication session. The session stop response is a response signal to the session stop request. The session halt response informs EVCC whether a halt of the power transfer process has been accepted or whether the power transfer process has been terminated successfully.

The service discovery response is a response signal to the service discovery request. The service discovery reply includes a listing of all services available in SECC. The service detail response is a response signal to the service detail request. The service detail response provides details about the service. The service selection response is a response signal to the service selection request. The service selection reply informs EVCC whether the selected service has been accepted.

The power supply response (power delivery response) is a response signal to a power supply request. The power supply response includes information indicating whether the power requested by the power supply request is available or whether EVSE accepts the standby requested by the power supply request. In addition, the power feed includes a EVSE status indicating the state of the EVSE or notifying the user of an event related to EVCC.

The charge loop response is a response signal to a charge loop request. The charge-loop-response informs EV of the status of EVSE and the current and voltage outputted by the present EVSE. The charge loop response includes a first parameter, a second parameter, and a third parameter. The first parameter indicates the current and voltage of the present EVSE. The second parameter indicates whether an upper limit has been reached for each of the current, voltage, and power of the present EVSE. The 3 parameter indicates the energy charged during the current service session

The communication session always begins with the session setup message pair described above and ends with a session stop message pair. EVCC may enter a first standby period during the communication session and resume communication after the first standby period has elapsed. All messages in a communication session have a session ID that allows the session to be managed at the application level. The session ID is negotiated between EVCC and SECC by a session configuration message pair. All messages except the Session Setup Request message use the same session ID.

FIG. 2 is a flowchart illustrating charge control according to the embodiment. The process illustrated in FIG. 2 is executed by ECU 16 when a predetermined charge-start condition is satisfied in the plug-in-state vehicle 100. The charge starting condition is satisfied, for example, when the vehicle 100 is connected to EVSE 300 and the plug-in condition described above is established. Each step in the flowchart is simply referred to as “S.”

Referring to FIG. 2, in S11, an ECU 16 (EVCC) initiates communication with a control device 310 (SECC) and performs service-selection and mode-selection through this communication. Specifically, ECU 16 and control device 310 selects a service for charging the battery 11 through the above service selection process. In addition, ECU 16 and control device 310 selects one of the scheduled control mode and the dynamic control mode according to the condition of the vehicle 100. For example, a dynamic control mode may be selected if EMS 500 request charging for energy management to the control device 310, and a scheduled control mode may be selected otherwise.

In S12, ECU 16 determines whether the scheduled control mode or the dynamic control mode is selected. When the scheduled control mode is selected in S11 (S12: Scheduled), the process proceeds to S21. In S21, ECU 16 generates a power transfer profile for the present charge session. The power transfer profile indicates a charging plan and corresponds to an example of “schedule information” according to the present disclosure. In this embodiment, a power transfer profile including a charge standby period is generated. In the following S22, ECU 16 determines whether or not a predetermined standby condition is satisfied. The standby condition can be set arbitrarily. For example, the standby condition may be satisfied when the current time is included in a predetermined time period (hereinafter, referred to as a “standby time period”). A time period in which the electricity rate is high or a time period in which the electricity demand is large may be set as the standby time period. In this embodiment, the power transfer profile indicates a standby time period.

When the standby condition is not satisfied (NO in S22), the process proceeds to S31. In S31, ECU 16 performs charge control of the battery 11. At the beginning of the charge control, ECU 16 negotiates with the control device 310 for a power transfer profile (S21) using the power transfer requirement, and the power transfer profile is modified as needed. Thereafter, ECU 16 performs charge control according to the agreed power transfer profile using the charge-loop requirement. The control device 310 basically controls the charger 331 in response to a demand from ECU 16.

In the following S32, ECU 16 determines whether or not the battery 11 has been charged. When the charge is not completed (NO in S32), the process returns to S12. On the other hand, if the charging is complete (YES in S32), ECU 16 terminates the charging control and power transfer process using the power supply request and the session stopping request in S33. As a result, the processing flow illustrated in FIG. 2 ends.

When the standby condition is satisfied (YES in S22), ECU 16 executes standby control in S23. FIG. 3 is a flow chart illustrating a detailed standby control in S23.

Referring to FIG. 3, in S51, ECU 16 obtains a standby time indicated by EV power profile of the power supply requirement and SOC of the battery 11 detected by BMS 11a. The standby time corresponds to the time from the standby start to the standby end in the charging plan. Subsequently, ECU 16 determines, by S52 to S55 process, whether all of the first to third requirements are satisfied for SOC and the standby time obtained in S51. The first requirement is that SOC of the battery 11 is greater than or equal to the first reference value (Th1). The second requirement is that the standby time is less than a second reference value (Th2). The third requirement is that the standby time is less than a third reference value (Th3). Each of Th1, Th2 is fixed. In one instance, Th1, Th2 is 20% and 60 minutes, respectively.

Specifically, in S52, S53, it is determined whether or not the first requirement and the second requirement are satisfied, respectively. If the remaining capacity (SOC) is smaller than Th1 value as indicated by the area R11 in FIG. 3 (NO in S52), the process proceeds to S581. If the standby time is longer than Th2 as indicated by the area R12 in FIG. 3 (NO in S53), the process proceeds to S581. If the remaining capacity (SOC) is greater than Th1 and the standby time is shorter than Th2 (YES in both S52, S53), ECU 16 sets Th3 in S54 based on SOC of the battery 11. ECU 16 increases Th3 as SOC of the battery 11 increases, for example, as shown in the graph in FIG. 3. Subsequently, ECU 16 determines whether the third requirement is satisfied in S55. If the standby time is longer than Th3 as indicated by the area R13 in FIG. 3 (NO in S55), the process proceeds to S581. If the standby time is shorter than Th3 as indicated by the area R14 in FIG. 3 (YES in S55), the process proceeds to S571. Proceeding to S571 means that all of the first through third requirements are met.

In S571, ECU 16 requests first standby (Standby) from EVSE 300. Subsequently, ECU 16 determines, in S572, whether the request for the first standby has been accepted by EVSE 300. Specifically, ECU 16 requests first standby to EVSE 300 by sending the above power supply request for the charge progress “standby” to the control device 310. After that, when ECU 16 receives a power supply response indicating acceptance of the request for the first standby from the control device 310, it is determined as YES in S572, and the process proceeds to S573.

In S573, ECU 16 puts the vehicle 100 into the first standby state. In the first standby (Standby), the power transfer is stopped, but the vehicle 100 stands by while the communication with EVSE 300 is maintained. In response to the standby request from ECU 16, the control device 310 controls the charger 331 to stop the power transfer, so that the transfer power is maintained at zero during the first standby. However, the contactors (SMR 12 and charge relay 13) provided in the path of the power transfer are kept closed. In the first standby, the communication function of ECU 16 is activated to maintain communication between ECU 16 and the control device 310.

In the following S574, ECU 16 determines whether or not a predetermined resumption condition is satisfied. In this embodiment, when the above standby time (S51) has elapsed after the vehicle 100 was put into the first standby state, the resumption condition is satisfied. While the resumption condition is not satisfied (NO in S574), S573, S574 is repeated and the vehicle 100 is maintained in the first standby state. When the resumption condition is satisfied (YES in S574), ECU 16 releases the standby of the vehicle 100 in S575. Specifically, ECU 16 resumes sending a charge control signal to the control device 310. Thereafter, the processing shown in FIG. 3 ends, and the processing proceeds to S31 of FIG. 2. Thus, the power transfer is resumed in S31. At the time of resumption, a sequence is executed immediately before the start of charging. If the first standby request is not accepted by EVSE 300 (NO in S572), the process similarly proceeds to S31 of FIG. 2. In the zero power interval indicated by the power transfer profile, S31 process controls the transfer power between the vehicle 100 and EVSE 300 to be zero or close to zero, even if the first standby request is not accepted.

In S581, ECU 16 requests second standby (Pause) from EVSE 300. Subsequently, ECU 16 determines, in S582, whether the request for the second standby has been accepted by EVSE 300. Specifically, ECU 16 sends the control device 310 a power supply request of the charging progress “stop” described above, and then sends a session stop request of the charging session “pause” described above to the control device 310, thereby requesting EVSE 300 to perform the second standby. Thereafter, when ECU 16 receives a session stop response from the control device 310 indicating acceptance of the request for the second standby, it is determined by S582 that the session-stop reply is YES, and the process proceeds to S583.

In S583, ECU 16 puts the vehicle 100 into the second standby state. In the second standby (Pause), the vehicle 100 stands by with both the power transfer and the communication with EVSE 300 stopped. The control device 310 stops the power transfer in response to the standby request from ECU 16, and stops the communication so that the communication is resumed when the above standby time (S51) has elapsed. During the second standby, ECU 16 maintains the contactors (SMR 12 and charge relay 13) in the path of the power transfer in the open state (cut-off state). Further, during the second standby, the communication function (communication module) of ECU 16 is stopped in order to suppress power dissipation.

In the following S584, ECU 16 determines whether or not a predetermined resumption condition is satisfied. In this embodiment, when the above standby time (S51) has elapsed since the vehicle 100 was put into the second standby state, the resumption condition is satisfied. While the resumption condition is not satisfied (NO in S584), S583, S584 is repeated and the vehicle 100 is maintained in the second standby state. When the resumption condition is satisfied (YES in S584), ECU 16 releases the standby of the vehicle 100 in S585. Specifically, after ECU 16 activates the communication function, it closes the contactors (SMR 12 and charge relay 13) provided in the path of the power transfer. The charge relay 13 is closed after the insulation check. ECU 16 then resumes sending a charge control signal to the control device 310. Thereafter, the processing shown in FIG. 3 ends, and the processing proceeds to S31 of FIG. 2. Thus, the power transfer is resumed in S31. At the time of resumption, the sequence is executed from the beginning. ECU 16 retains information (e.g., session ID) prior to the second standby (Pause) until the connector 320a is removed. Also, when the request for the second standby is not accepted by EVSE 300 (NO in S582), the process similarly proceeds to S31 of FIG. 2.

Referring back to FIG. 2, if the dynamic control mode is selected in S11 (S12: Dynamic), the process proceeds to S41. In S41, ECU 16 determines whether second standby (Pause) is requested from EVSE 300. When ECU 16 has not received the request for the second standby (NO in S41), the process proceeds to S30.

In S30, ECU 16 sends data for controlling the charge of the battery 11 to EVSE 300. At the beginning of the charge control, ECU 16 sends the charge parameter limits to the control device 310. Thereafter, ECU 16 periodically notifies the control device 310 of the present charge parameter using the charge-loop requirement. The charge control in the dynamic control mode is left to the control device 310. The control device 310 may control the charger 331 in response to a request from EMS 500. When S30 process is executed, the process proceeds to S32 described above.

When ECU 16 receives the second standby request (YES in S41), ECU 16 puts the vehicle 100 into the second standby state in S42 as in S583 of FIG. 3. In the following S43, ECU 16 determines whether or not a predetermined resumption condition is satisfied. In this embodiment, when ECU 16 receives a standby release request from the control device 310, the resumption condition is satisfied. While the resumption condition is not satisfied (NO in S43), S42, S43 is repeated and the vehicle 100 is maintained in the second standby state. When the resumption condition is satisfied (YES in S43), ECU 16 releases the standby of the vehicle 100 in S44 in the same manner as in S585 of FIG. 3. Thereafter, the process returns to S12.

As described above, the power transfer method according to this embodiment includes the respective processes illustrated in FIGS. 2 and 3. ECU 16 (control device) included in the vehicle 100 requests standby to EVSE 300 (electrical equipment) during power transfer (S571, S581 in FIG. 3). When this standby request is accepted by EVSE 300, the vehicle 100 is put into the standby state (S573, S583 in FIG. 3), and when the resumption condition is satisfied when the vehicle 100 is in the standby state, the power transfer is resumed (S575, S585 in FIG. 3). Then, ECU 16 determines which of the first standby and the second standby is to be requested to EVSE 300 by using the remaining capacity of the battery 11 (energy storage device).

According to the above configuration, it is possible to appropriately use the first standby in which the power transfer can be resumed at an early stage and the second standby with smaller power consumption according to the remaining capacity of the battery 11.

More specifically, in the above embodiment, ECU 16 determines which of the first standby and the second standby is to be requested to the EVSE 300 based on the first to third requirements (see FIG. 3). According to such a configuration, an appropriate standby state is selected according to the situation. Then, it is possible to suppress the power consumption due to the long-term standby while suppressing the delay in restarting the power transfer from the short-term standby. Further, by selecting the second standby when the remaining capacity of the battery 11 is smaller than the first reference value, it is also possible to prevent the power of the battery 11 from being excessively reduced due to the power consumption during standby. Further, by selecting the first standby when the standby time is short, it is also possible to suppress an increase in the number of times of driving the high-voltage relay (and thus deterioration of the relay).

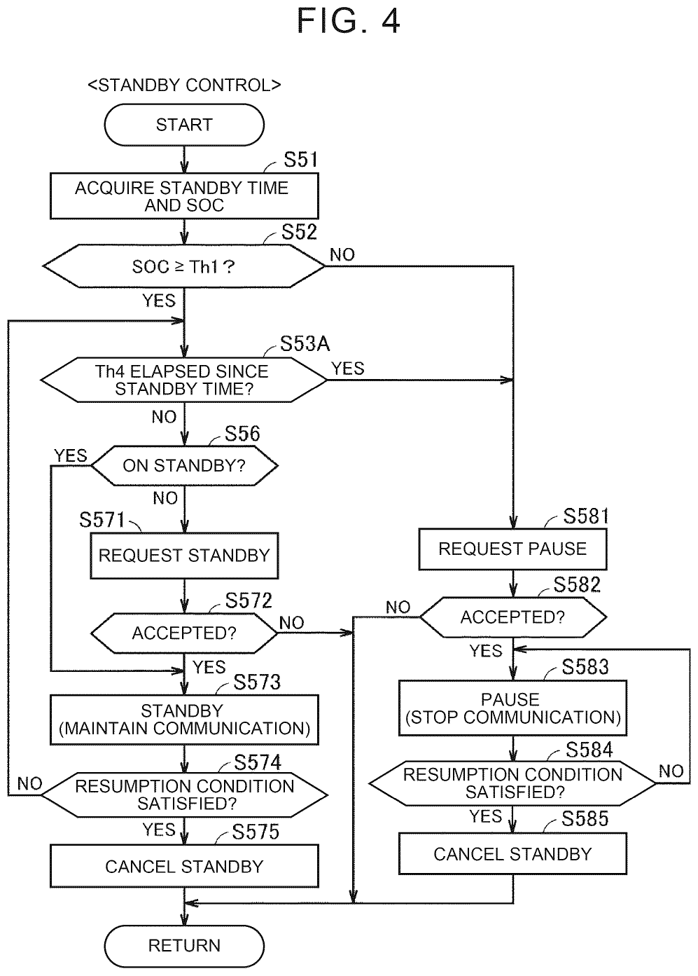

In the above-described embodiment, ECU 16 requests the first standby and the second standby in the scheduled control mode, but ECU 16 requests neither the first standby nor the second standby in the dynamic control mode (sec FIGS. 3 and 4). In this way, power transfer control (charge control) that is entrusted to EVSE 300 in the dynamic control mode is smoothly performed. However, the present disclosure is not limited thereto, and ECU 16 may be configured to require the first standby in the dynamic-control mode.

In the above embodiment, the first power transfer in which the electrical equipment transfers the electric power for charging the energy storage device to the vehicle has been exemplified. However, the type of the power transfer is not limited to the first power transfer (charging), and the control illustrated in FIGS. 2 and 3 may be applied to the second power transfer in which the vehicle transfers the electric power discharged from the energy storage device to the electrical equipment. Alternatively, the control illustrated in FIGS. 2 and 3 may be applied to the third power transfer in which electric power is exchanged bidirectionally between the vehicle and the electrical equipment. Note that each of the first and second power transfers may be conductive power transfer (CPT) or wireless power transfer (WPT). The third power transfer is also referred to as “bidirectional power transfer (BPT)”.

ECU 16 may execute the control illustrated in FIG. 4 instead of the control illustrated in FIG. 3. FIG. 4 is a flowchart illustrating a modification of the process illustrated in FIG. 3. In the process illustrated in FIG. 4, a S53A, S56 is adopted instead of S53 to S55 (FIG. 3).

Referring to FIG. 4, when it is determined in S52 that the remaining capacity (SOC) is equal to or larger than Th1 (YES in S52), the process proceeds to S53A. In S53A, ECU 16 determines whether the time elapsed since the start of the standby is equal to or greater than the fourth reference value (Th4). When the vehicle 100 is not in the standby state, it is determined that the vehicle is NO in S53A, and the process proceeds to S56. In S56, ECU 16 determines whether the vehicle 100 is in the first standby state. If the vehicle 100 is not in the first standby state (NO in S56), the process proceeds to S571. Then, in S571, a first Standby is requested for EVSE 300. On the other hand, if the vehicle 100 is in the first standby state (YES in S56), the process proceeds to S573. Then, the first standby of the vehicle 100 is continued in S573. In S571 to S575 in FIG. 4, the same process as that of S571 to S575 in FIG. 3 is executed. However, if it is determined that S574 is NO, the process returns to S53A. If it is determined in S574 that the resumption condition is satisfied, a time corresponding to Th4 has elapsed since the start of the first standby (YES in S53A), the process proceeds to S581. Then, in S581, second standby (Pause) request for EVSE 300 is executed. In S581 to S585 in FIG. 4, the same process as that of S581 to S585 in FIG. 3 is executed. Therefore, when the request for the second standby is accepted by EVSE 300 during the first standby (YES in S582), the standby state of the vehicle 100 is switched from the first standby state to the second standby state in S583.

With the control of the modification as well, it is possible to put the vehicle into an appropriate standby state according to the situation of the vehicle when putting the vehicle on standby with power transfer stopped.

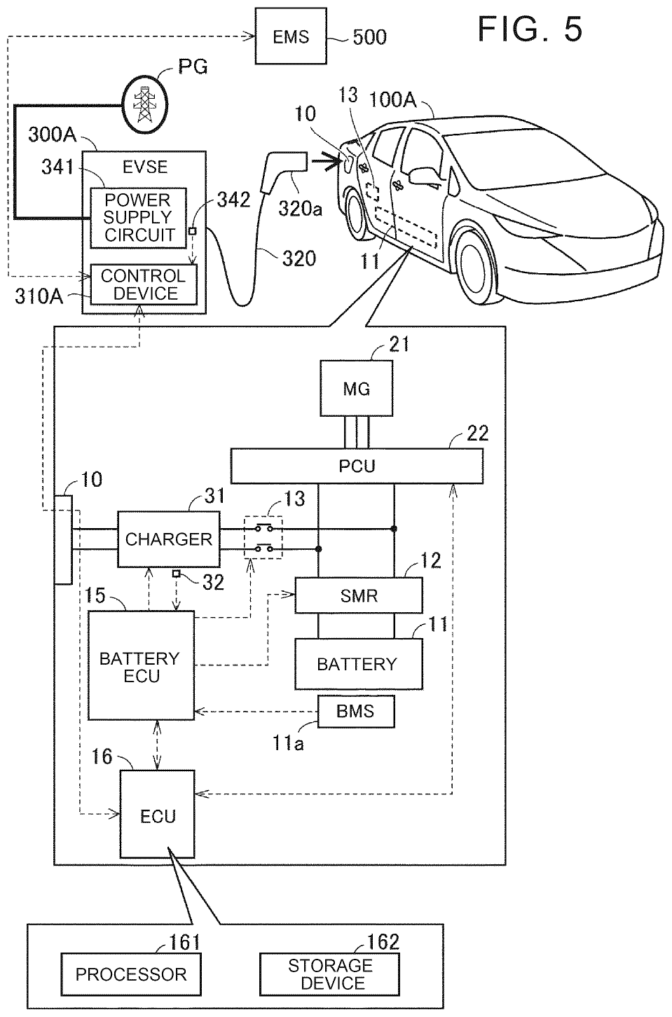

EVSE 300 shown in FIG. 1 is configured to provide DC power to vehicle 100. However, the configuration of the vehicle and EVSE is not limited to the configuration illustrated in FIG. 1. FIG. 5 is a diagram illustrating a modification of the configuration illustrated in FIG. 1. In the power transfer system shown in FIG. 5, the charger is mounted on the vehicle instead of EVSE.

Referring to FIG. 5, a vehicle 100A includes a charger 31 and a detector 32. The charger 31 includes a power conversion circuit (for example, an inverter) and is configured to be capable of adjusting a charging current. The power conversion circuitry performs DC (DC)/AC (AC) conversion. The detector 32 includes various sensors that detect charge parameters (current, voltage, and the like), and outputs the detection result to ECU 15. ECU 15 controls the charger 31 in accordance with an instruction from ECU 16. EVSE 300A also includes a control device 310A, power supply circuitry 341, and a detector 342. The power supply circuitry 341 converts the electric power received from the power system PG into electric power suitable for power supply to vehicle, and outputs the converted electric power to the charge cable 320. The detector 342 includes various sensors for detecting power supply parameters (current, voltage, and the like), and outputs the detection result to the control device 310A. EVSE 300A provides AC power to the vehicle 100A. The control device 310A is configured to communicate with each of ECU 16 and EMS 500. In such a power transfer system, ECU 16 controls the charger 31 to control the charge of the battery 11. In the scheduled control mode, ECU 16 controls the charger 31 according to the agreed power transfer profile. In the dynamic-control mode, ECU 16 controls the charger 31 in accordance with an instruction from the control device 310A.

Each of the vehicle 100, 100A illustrated in FIGS. 1 and 5 is merely an exemplary vehicle that performs power transfer. Other vehicle configurations may also be employed. For example, vehicle may have a configuration that can accommodate both AC and DC charging. In addition, the vehicle may be configured to be capable of contactless charging. The configurations illustrated in FIGS. 1 and 5 may be changed so that external power supply (power supply from the battery 11 to the outside of the vehicle) can be performed. For example, the chargers 331 and 31 may be changed to bidirectional chargers and dischargers. Further, each of EVSE 300, 300A illustrated in FIGS. 1 and 5 is merely an example of the electrical equipment. Any electrical equipment (accessories, devices, power outlets, appliances, etc.) can be employed that provides electrical power to EV and communicates with EV as needed.

The embodiment disclosed herein should be considered as illustrative and not restrictive in all respects. The scope of the present disclosure is shown by the claims rather than the above embodiment, and is intended to include all modifications within the meaning and the scope equivalent to those of the claims.

What is claimed is:

1. A vehicle including a control device and an energy storage device, wherein:
the vehicle is configured to perform power transfer between the vehicle and electrical equipment while communicating with the electrical equipment;
the control device is configured to
send a request for standby to the electrical equipment during the power transfer, and put the vehicle into a standby state when the request for the standby is accepted by the electrical equipment, and
resume the power transfer when a resumption condition is satisfied while the vehicle is in the standby state;
the standby includes first standby in which the vehicle stands by with the power transfer stopped but with communication with the electrical equipment maintained, and second standby in which the vehicle stands by with both the power transfer and the communication with the electrical equipment stopped; and
the control device determines which of the first standby and the second standby is to be requested to the electrical equipment by using a remaining capacity of the energy storage device.

2. The vehicle according to claim 1, wherein:
the control device is configured to acquire schedule information indicating the resumption condition for the power transfer;
the resumption condition is satisfied when a predetermined standby time has elapsed since the vehicle was put into the standby state; and
the control device determines which of the first standby and the second standby is to be requested to the electrical equipment by using the remaining capacity of the energy storage device and the standby time indicated by the schedule information.

3. The vehicle according to claim 2, wherein the control device is configured to, when a standby condition is satisfied
request the second standby to the electrical equipment when the remaining capacity of the energy storage device is less than a first reference value,
request the second standby to the electrical equipment when the standby time is longer than a second reference value, and
when the remaining capacity of the energy storage device is greater than the first reference value and the standby time is shorter than the second reference value, set a third reference value based on the remaining capacity of the energy storage device, and determine which of the first standby and the second standby is to be required to the electrical equipment based on whether the standby time is shorter than the third reference value.

4. The vehicle according to claim 1, wherein:
in the first standby, a contactor in a path of the power transfer is maintained in a closed state; and
in the second standby, the contactor in the path of the power transfer is maintained in an open state.

5. The vehicle according to claim 1, wherein:
the control device is configured to operate in a first control mode and a second control mode, the first control mode being a mode in which the power transfer is performed under control of the vehicle, and the second control mode being a mode in which the power transfer is performed under control of the electrical equipment; and
the control device requests the first standby and the second standby when operating in the first control mode, and does not request the second standby when operating in the second control mode.
